(19) United States
(12) Patent Application Publication
(10) Pub. No.: US 2020/0391961 A1
(43) Pub. Date: Dec. 17, 2020

(54) SUBSTRATE TRANSFERRING APPARATUS AND SUBSTRATE TRANSFERRING METHOD USING THE SAME

(71) Applicant: Samsung Display Co., Ltd., Yongin-si (KR)

(72) Inventor: Woo Cheol SEO, Asan-si (KR)

(21) Appl. No.: 16/888,852

(22) Filed: Jun. 1, 2020

(30) Foreign Application Priority Data
Jun. 12, 2019 (KR) 10-2019-0069325

(51) Int. Cl. B65G 47/91; B25J 15/06; B65G 43/08

(52) U.S. Cl. CPC B65G 47/91; B65H 3/0883; B65G 43/08; B25J 15/0616

(57) ABSTRACT

A substrate transferring apparatus for applying suction to and transferring the substrate includes a suction pad including a flat suction surface including poly oxy methylene (POM) and a plurality of suction holes, a duct for applying suction to withdraw air through the suction holes of the suction pad, and a controller configured to move the suction pad and to control suction of the air.

This application claims priority from and the benefit of Korean Patent Application No. 10-2019-0069325, filed on Jun. 12, 2019, which is hereby incorporated by reference for all purposes as if fully set forth herein.

### BACKGROUND

### Field

Exemplary embodiments of the invention relate generally to a substrate transferring apparatus, and a substrate transferring method using the substrate transferring apparatus and, more specifically, to a substrate transferring apparatus capable of transferring a substrate without damage, and a substrate transferring method using the substrate transferring apparatus.

### Discussion of the Background

A flat panel display apparatus is widely used as a display device of an electronic device because such a display apparatus is lightweight and thin compared to a cathode-ray tube (CRT) display apparatus. Typical examples of this type of display apparatus are a plasma display apparatus, a liquid crystal display (LCD) apparatus, and an organic light emitting display (OLED) apparatus.

These types of display apparatus include a structure stacked on a substrate, and a method of manufacturing the display apparatus typically includes transferring the substrate for various processing steps. At this time, a substrate transfer apparatus may be used for transferring the substrate and there is a need to transfer the substrate without damage.

The above information disclosed in this Background section is only for understanding of the background of the inventive concepts, and, therefore, it may contain information that does not constitute prior art.

### SUMMARY

One or more exemplary embodiments of the inventive concepts provides a substrate transferring apparatus capable of transferring a substrate without damage.

One or more exemplary embodiments of the inventive concepts also provide a substrate transferring method using the substrate transferring apparatus.

Additional features of the inventive concepts will be set forth in the description which follows, and in part will be apparent from the description, or may be learned by practice of the inventive concepts.

According to an exemplary embodiment of the inventive concepts, a substrate transferring apparatus for applying suction to and transferring the substrate includes a suction pad including poly oxy methylene (POM) and having a flat suction surface with a plurality of suction holes, a duct for applying suction to withdraw air through the suction holes of the suction pad, and a controller configured to move the suction pad and to control suction of the air.

In an exemplary embodiment, the suction pad may have a surface resistance of about 10⁶ to 10⁹ ohms/square.

In an exemplary embodiment, the suction pad may exclude a carbon component other than a carbon component in the poly oxy methylene (POM).

In an exemplary embodiment, the suction pad may be larger than the substrate.

In an exemplary embodiment, the suction pad may have a first suction hole group including a plurality of suction holes and a second suction hole spaced apart from the first suction hole group and having a plurality of suction holes on the suction surface to simultaneously apply suction to at least two substrates.

In an exemplary embodiment, an upper surface of the substrate may be attached under the suction pad.

In an exemplary embodiment, a lower surface of the substrate may be attached on the suction pad.

In an exemplary embodiment, the suction surface may have a circular shape.

In an exemplary embodiment, the suction holes may be arranged along a first direction and a second direction perpendicular to the first direction on the suction surface.

In an exemplary embodiment, the controller may move the suction pad in a first direction, a second direction perpendicular to the first direction, and a third direction perpendicular to the first and second directions.

In an exemplary embodiment, the substrate may be a flexible substrate.

According to an exemplary embodiment of the inventive concepts, a substrate transferring method includes an approaching step wherein a suction surface of a suction pad of a substrate transferring apparatus is located within 2 mm of a substrate, a suction step wherein the substrate is attached on the suction surface by withdrawing air between the suction surface and the substrate through a plurality of suction holes formed in suction surface in a state where the suction surface and the substrate are spaced apart from each other, and a transferring step wherein the suction pad is moved.

In an exemplary embodiment, the suction pad may include poly oxy methylene (POM), and the suction surface of the suction pad is flat.

In an exemplary embodiment, the suction pad may have a surface resistance of about 10⁶ to 10⁹ ohms/square.

In an exemplary embodiment, the substrate may be a flexible substrate.

In an exemplary embodiment, the substrate may be attached under the suction pad, and the substrate may be moved while being attached under the suction pad.

According to the exemplary embodiments of the present inventive concepts, a substrate transferring apparatus may apply suction to and transfer a substrate. The substrate transferring apparatus comprises a poly oxy methylene (POM), has a flat suction surface, a suction pad formed with a plurality of suction holes, a duct to apply suction to withdraw air through the suction holes of the suction pad, and a controller for moving the suction pad and controlling suction of the air

Since the suction surface is flat, suction may be provided uniformly even when the substrate is flexible, so that it is possible to minimize the damage of the substrate. The suction pad may have a surface resistance value of about 10⁶ to 10⁹ ohm/square. Therefore, it is possible to minimize the damage of the substrate due to static electricity during the transfer of the substrate

In addition, since a plurality of the suction holes are formed, the substrate may be prevented from falling even when the suction force is lost in some of the suction holes.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is a side view briefly illustrating a substrate transfer apparatus according to an exemplary embodiment of the inventive concepts.

FIG. 2 is a plan view illustrating a substrate, a flexible film, and a driving circuit unit of FIG. 1.

FIGS. 3 and 4 are perspective views illustrating in detail the suction unit of the substrate transfer apparatus of FIG. 1.

FIGS. 5A and 5B are cross-sectional views illustrating applying suction to a substrate using the vacuum suction pads of FIGS. 3 and 4.

FIG. 6 is a side view briefly showing a substrate transferring apparatus according to an exemplary embodiment of the inventive concepts.

FIG. 7 is a cross-sectional view showing a vacuum suction pad of the substrate transferring apparatus of FIG. 6.

FIG. 8 is a plan view of a vacuum suction pad of the substrate transferring apparatus of FIG. 6.

FIG. 9 is a side view briefly showing a substrate transferring apparatus according to an exemplary embodiment of the inventive concepts.

FIG. 10 is a flowchart showing a substrate transferring method according to an exemplary embodiment of the inventive concepts.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

In the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order where practicable. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments are described herein with reference to sectional and/or exploded illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As is customary in the field, some exemplary embodiments are described and illustrated in the accompanying drawings in terms of functional blocks, units, and/or modules, such as a controller. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some exemplary embodiments may be physically separated into two or more interacting and discrete blocks, units, and/or modules without departing from the scope of the inventive concepts. Further, the blocks, units, and/or modules of some exemplary embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Hereinafter, the inventive concepts will be explained in detail with reference to the accompanying drawings.

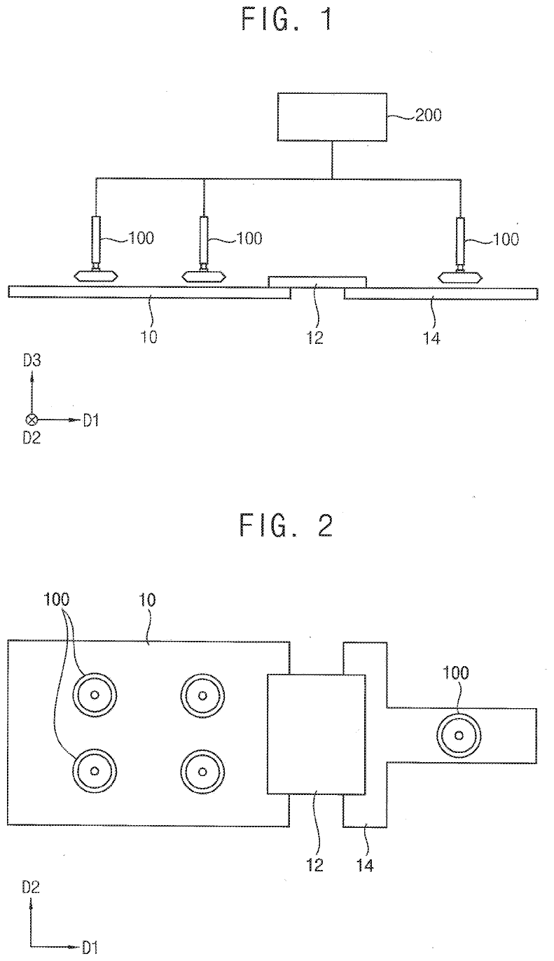

FIG. 1 is a side view schematically illustrating a substrate transfer apparatus according to an exemplary embodiment of the inventive concepts. FIG. 2 is a plan view illustrating a substrate, a flexible film, and a driving circuit unit of FIG. 1.

Referring to FIGS. 1 and 2, the substrate transfer apparatus may include a plurality of suction units 100 and a controller 200 for controlling the suction units 100.

The suction unit 100 may apply suction to a surface of an object to be transferred. For example, the suction unit 100 may attach and transfer the display apparatus or a substrate thereof. For example, the suction unit 100 may apply suction to a surface of a display apparatus to attach to the display apparatus, and the display apparatus may include a substrate 10, a driving circuit part 14 spaced apart from the substrate 10, and a flexible film 12. The substrate 10 may be disposed on a plane formed by a first direction D1 and a second direction D2 perpendicular to the first direction D1. The driving circuit part 14 may be spaced apart from the substrate 10 in the first direction D1. The flexible film 12 may connect the driving circuit part 14 and the substrate 10.

A plurality of the suction units 100 may attach to the substrate 10 and the driving circuit part 14 at appropriate positions and lift the substrate 10 and the driving circuit part 14 in a third direction D3, which is perpendicular to the first and second directions D1 and D2, to transfer the display apparatus.

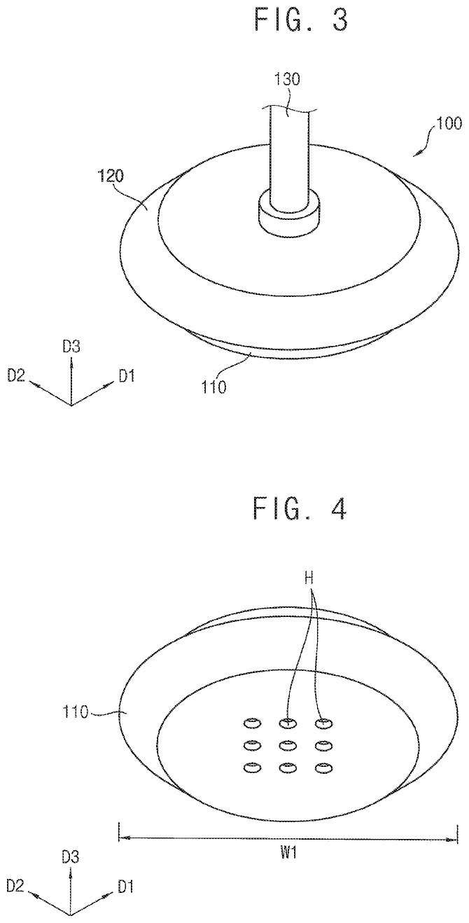

Each suction unit 100 may include a suction pad for attaching to the display apparatus, a cover coupled to the suction pad, and a duct for withdrawing air. The detailed structure of the suction unit 100 will be described later with reference to FIGS. 3 and 4.

The controller 200 may move the suction unit 100 and control suction of the air. The controller 200 may further include a vacuum generator (not shown) connected to the duct to provide a vacuum for withdrawing the air.

Specifically, the controller 200 may move a suction surface of the suction pad of the suction unit 100 to approach within 2 mm of the substrate 10. The controller 200 may control the suction unit 100 to withdraw air between the suction surface and the substrate 10 through a plurality of suction holes H formed in the suction surface in a state where the suction surface and the substrate 10 are spaced apart from each other, so that the substrate may be attached to the suction surface. Thereafter, the controller 200 may move the suction unit 100 to transfer the substrate 10.

FIGS. 3 and 4 are perspective views illustrating in detail the suction unit of the substrate transfer apparatus of FIG. 1.

Referring to FIGS. 3 and 4, the suction unit 100 may include a suction pad 110, a cover 120, and a duct 130.

The suction pad 110 may be formed of poly oxy methylene (POM). The suction pad 110 may have a flat suction surface, and a plurality of suction holes H may be formed in the suction surface.

Poly oxy methylene is a type of engineered plastic with excellent in strength and wear resistance. As such, poly oxy methylene may be used in variety ways, such as for automotive parts and gears of electronic products having excellent strength and wear resistance.

Since the suction surface is flat, suction may be provided uniformly even when the substrate 10 is flexible, so that it is possible to minimize the damage of the substrate (10).

The suction pad 110 may have a surface resistance value of about 10⁶ to 10⁹ ohms/square. When the surface resistance value of the suction pad 110 exceeds 10⁹ ohms/square, the conductivity of the suction pad 110 is so low that it may be difficult to discharge the static electricity generated during transfer of the substrate 10 to the outside through the suction pad 110. When the surface resistance of the suction pad 110 is less than about 10⁶ ohms/square, the conductivity of the suction pad 110 is too high, so that external static electricity from the suction pad 110 may be provided to the substrate 10 during transfer of the substrate 10. Therefore, when the surface resistance value of the suction pad 110 can be controlled within an appropriate range, it is possible to minimize the damage of the substrate 10 due to static electricity during the transfer of the substrate 10.

The suction pad 110 does not include a carbon component material except for the carbon component in poly oxy methylene (POM). That is, in a process of forming the suction pad 110, an additional carbon component such as carbon nanotube compound is excluded. In the case of commonly used conductive polyoxymethylene of the comparative art, a carbon nanotube compound or the like is coated or blended to include a carbon component in addition to the carbon component in the polyoxymethylene. However, in this case, it is impossible to achieve a proper surface resistance range of the suction pad 110.

The suction surface of the suction pad 110 may be circular, but is not limited thereto. The suction surface of the suction pad 110 may be a flat shape that can be in contact with the substrate 10. The suction surface may have an appropriate size to apply suction to and attach the substrate 10 or the driving circuit part 14. As an example, a diameter of the suction surface may be about 28 mm.

The suction holes H may be arranged along the first direction D1 and a second direction D2 perpendicular to the first direction D1 on the suction surface. In the drawing, the holes H are arranged in a square shape along the first direction D1 and the second direction D2, but are not limited thereto. For example, the holes H1 may be arranged in a rectangular shape or a circular shape without departing from the scope of the inventive concepts.

The cover 120 may be coupled to the suction pad 110, and may be located on the suction pad 110. The cover 120 may form a space with the suction pad 110 so that air may be withdrawn into the duct 130 through the space and the suction holes H of the suction surface.

The duct 130 may be connected to the cover 120 and provide a vacuum, through the space and the suction holes H, to withdraw the air around the suction surface of the suction surface of the suction pad 110.

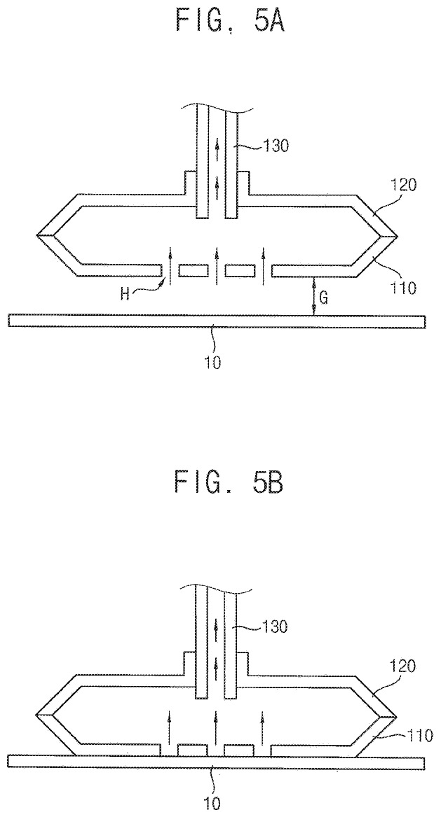

FIGS. 5A and 5B are cross-sectional views illustrating applying suction to a substrate using the vacuum suction pads of FIGS. 3 and 4.

Referring to FIGS. 5A and 5B, the substrate 10 under the suction surface of the suction pad 110 is attached thereto. The substrate 10 may be transferred while the substrate 10 is attached under the suction pad 110. The substrate 10 may be a flexible substrate.

Specifically, the suction surface may be moved toward the substrate 10 to approach within 2 mm. For example, the suction surface may be moved to a position 1 mm above the substrate 10. Subsequently, the air between the suction surface and the substrate 10 is withdrawn through the plurality of suction holes H formed in the suction surface in a state where the suction surface and the substrate 10 are separated from each other. Therefore, the substrate 10 may be drawn to and attached to the suction surface, and then the substrate 10 may be transferred to a desired position.

At this time, since the suction surface is flat, even when the substrate 10 is flexible, suction may be provided uniformly, and it is possible to minimize the damage of the substrate 10. In addition, the suction pad 110 includes poly oxy methylene (POM) and has a surface resistance value of about 10⁶ to 10⁹ ohms/square, thereby minimizing damage to the substrate 10 due to static electricity. In addition, since there are a plurality of suction holes H, the substrate 10 may be prevented from falling even when the suction force is lost in some of the suction holes H.

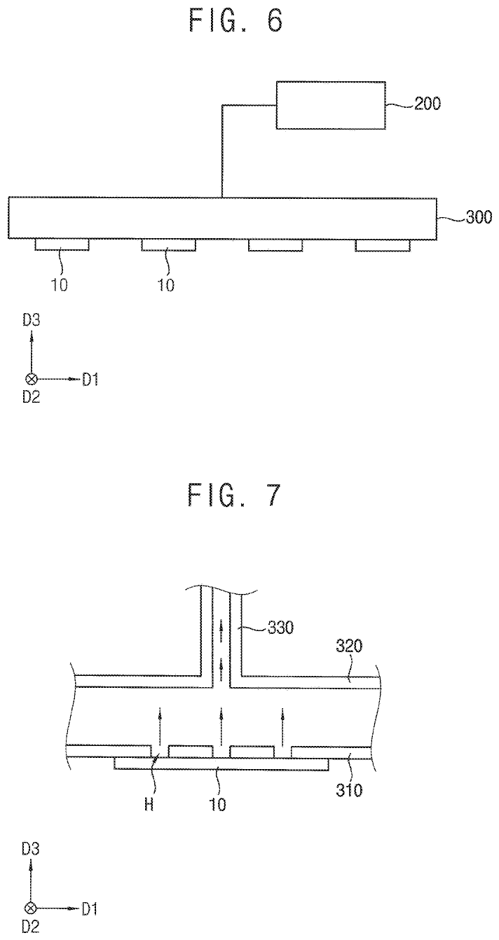

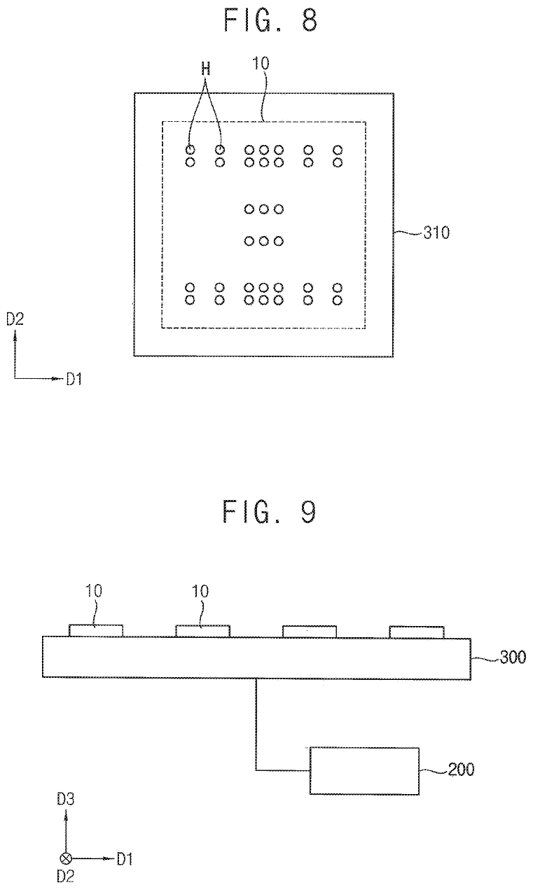

FIG. 6 is a side view briefly showing a substrate transferring apparatus according to an exemplary embodiment of the inventive concepts. FIG. 7 is a cross-sectional view showing a vacuum suction pad of the substrate transferring apparatus of FIG. 6. FIG. 8 is a plan view of a vacuum suction pad of the substrate transferring apparatus of FIG. 6.

Referring to FIGS. 6 to 8, the substrate transferring apparatus may include a suction unit 300 and a controller 200. The substrate transferring apparatus is substantially the same as the substrate transfer apparatus of FIG. 1 except for the shape of the suction unit 300. Therefore, repeated description will be omitted.

The suction unit 300 may include a suction pad 310, a cover 320, and a duct 330.

The suction pad 310 may be formed of poly oxy methylene (POM). The suction pad 310 may have a flat suction surface, and a plurality of suction holes H may be formed in the suction surface. In an embodiment, the suction pad 310 may be larger than the substrate 10, and a plurality of substrates 10 may be attached to one suction pad 310 (refer to FIG. 6).

That is, the suction pad 310 may include a first suction hole group including a plurality of suction holes on the suction surface and a second suction hole group which is spaced apart from the first suction hole group and includes a plurality of suction holes on the suction surface for simultaneously applying suction to at least two or more substrates 10. For example, FIG. 8 is a plan view showing an arrangement of the suction holes H of one suction hole group. The suction holes H may be arranged along the first direction D1 and a second direction D2 perpendicular to the first direction D1 on the suction surface.

The suction pad 310 may have a surface resistance value of about 10⁶ to 10⁹ ohms/square. The suction pad 110 excludes a carbon component material except for a carbon component in poly oxy methylene (POM).

The cover 320 may be coupled to the suction pad 310, and may be located on the suction pad 310. The cover 320 may form a space with the suction pad 310 so that air may be withdrawn into the duct 330 through the suction hole H of the suction surface and the space.

The duct 330 may be connected to the cover 320, and provide a vacuum, through the space and the suction hole H to withdraw the air adjacent the suction surface of the suction pad 310.

FIG. 9 is a side view briefly showing a substrate transferring apparatus according to an exemplary embodiment of the inventive concepts.

Referring to FIG. 9, the substrate transferring apparatus may be substantially the same as the substrate transferring apparatus of FIG. 6, except that the substrate transferring apparatus has a suction surface formed on an upper surface of the suction unit 300. Therefore, repeated description will be omitted.

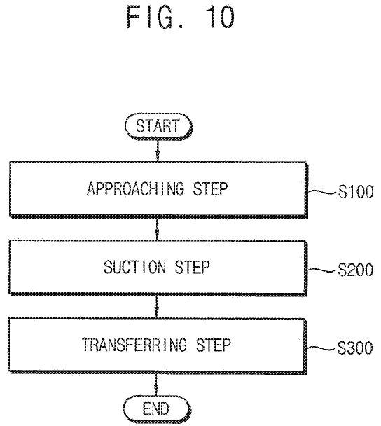

FIG. 10 is a flowchart showing a substrate transferring method according to an exemplary embodiment of the inventive concepts.

Referring to FIG. 10, the substrate transferring method includes an approaching step S100, wherein a suction surface of a suction pad of a substrate transfer apparatus is positioned within 2 mm on the substrate, a suction step S200, wherein the substrate is drawn to and attached to the suction surface by withdrawing air between the suction surface and the substrate through a plurality of suction holes formed in suction surface in a state where the suction surface and the substrate are spaced apart from each other, and a transferring step S300, wherein the suction pad is moved so as to transfer the substrate.

The suction pad may include poly oxy methylene (POM), and the suction surface of the suction pad may be flat. The suction pad may have a surface resistance value of about 10⁶ to 10⁹ ohms/square. The substrate may be a flexible substrate. The substrate may be drawn by suction to the suction surface of the suction pad, and the substrate may be transferred while the substrate is attached under the suction pad.

In embodiments of the present invention, according to the substrate transfer method using the substrate transfer apparatus and the substrate transferring apparatus, the substrate is attached to the suction pad and transferred. The substrate transferring apparatus includes a suction pad formed of a poly oxy methylene (POM) material and having a flat suction surface provided with a plurality of suction holes, a duct for withdrawing air through the suction holes of the suction pad, and a controller for moving the suction pad and controlling suction of the air

Since the suction surface is flat, suction may be provided uniformly even when the substrate is flexible, so that it is possible to minimize the damage of the substrate. The suction pad may have a surface resistance value of about 10⁶ to 10⁹ ohms/square. Therefore, it is possible to minimize the damage of the substrate due to static electricity during the transfer of the substrate.

In addition, since a plurality of the suction holes are provided, the substrate may be prevented from falling even when the suction force is lost in some of the suction holes.

The present invention can be applied to manufacturing organic light emitting display devices and various electronic devices including the same. For example, the present invention can be applied to transferring a substrate for manufacturing a mobile phone, a smart phone, a video phone, a smart pad, a smart watch, a tablet PC, a car navigation system, a television, a computer monitor, a notebook, and the like.

The foregoing is illustrative of the inventive concepts and is not to be construed as limiting thereof. Although a few exemplary embodiments of the inventive concepts have been described, those skilled in the art will readily appreciate that many modifications are possible in the exemplary embodiments without materially departing from the novel teachings and advantages of the inventive concepts. All such modifications are intended to be included within the scope of the inventive concepts as defined in the claims. In the claims, means-plus-function clauses are intended to cover the structures described herein as performing the recited function and not only structural equivalents but also equivalent structures. Therefore, it is to be understood that the foregoing is illustrative of the inventive concepts and is not to be construed as limited to the specific exemplary embodiments disclosed, and that modifications to the disclosed exemplary embodiments, as well as other exemplary embodiments, are intended to be included within the scope of the appended claims. Accordingly, the inventive concepts are not limited to such embodiments, but rather to the broader scope of the appended claims and various obvious modifications and equivalent arrangements as would be apparent to a person of ordinary skill in the art.

What is claimed is:

1. A substrate transferring apparatus for applying suction to and transferring the substrate, comprising:
a suction pad including poly oxy methylene (POM), the suction pad having a flat suction surface with a plurality of suction holes;
a duct for applying suction to withdraw air through the suction holes of the suction pad; and
a controller configured to move the suction pad and to control suction of the air.

2. The substrate transferring apparatus of claim 1, wherein the suction pad has a surface resistance of about 10⁶ to 10⁹ ohms/square.

3. The substrate transferring apparatus of claim 1, wherein the suction pad excludes a carbon component other than a carbon component in the poly oxy methylene (POM).

4. The substrate transferring apparatus of claim 1, wherein the suction pad is configured to be larger than the substrate to be transferred.

5. The substrate transferring apparatus of claim 4, wherein the suction pad has a first suction hole group including a first plurality of suction holes and a second suction hole group spaced apart from the first suction hole group and having a second plurality of suction holes on the suction surface at a position configured to simultaneously apply suction to at least two substrates.

6. The substrate transferring apparatus of claim 1, wherein the suction pad is configured to attach to an upper surface of the substrate.

7. The substrate transferring apparatus of claim 1, wherein the suction pad is configured to attach to a lower surface of the substrate.

8. The substrate transferring apparatus of claim 1, wherein the suction surface has a circular shape.

9. The substrate transferring apparatus of claim 8, wherein the suction holes are arranged along a first direction and a second direction perpendicular to the first direction on the suction surface.

10. The substrate transferring apparatus of claim 1, wherein the controller moves the suction pad in a first direction, a second direction perpendicular to the first direction, and a third direction perpendicular to the first and second directions.

11. The substrate transferring apparatus of claim 1, wherein the suction holes are arranged along a first direction and a second direction perpendicular to the first direction on the suction surface.

12. A substrate transferring method, the method comprising:
an approaching step wherein a suction surface of a suction pad of a substrate transferring apparatus is positioned within 2 mm on a substrate;
a suction step wherein the substrate is attached to the suction surface by applying suction to withdraw air between the suction surface and the substrate through a plurality of suction holes formed in suction surface, wherein the suction surface and the substrate are initially spaced apart from each other and then drawn together; and
a transferring step wherein the suction pad is moved.

13. The method of claim 12, further comprising providing the suction surface with a flat surface formed of poly oxy methylene (POM).

14. The method of claim 13, further comprising limiting a surface resistance of the suction pad to about 10⁶ to 10⁹ ohms/square.

15. The method of claim 12, further comprising configuring the suction pad for transferring a flexible substrate.

16. The method of claim 12, wherein the substrate is attached under the suction pad, and the substrate is moved while being attached under the suction pad.
